(19) United States
(12) Patent Application Publication
(10) Pub. No.: US 2018/0159239 A1
(43) Pub. Date: Jun. 7, 2018

(54) LOW LOSS ELECTRICAL TRANSMISSION MECHANISM AND ANTENNA USING SAME

(71) Applicant: Wafer LLC, Hanover, NH (US)

(72) Inventors: Greg Wyler, Stuart, FL (US); Dedi David Haziza, Kiryat Motzkin (IL)

(21) Appl. No.: 15/824,996

(22) Filed: Nov. 28, 2017

Related U.S. Application Data
(60) Provisional application No. 62/523,498, filed on Jun. 22, 2017.
(60) Provisional application No. 62/431,393, filed on Dec. 7, 2016.

(51) Int. Cl. H01Q 13/20; H04B 1/58; H01Q 1/38; H04B 1/52; H04B 3/56

(52) U.S. Cl. CPC H01Q 13/206; H04B 1/586; H04B 3/56; H04B 1/52; H01Q 1/38

(57) ABSTRACT

An electro-magnetic transmission line system having very low loss, which includes a low dielectric material proximate to a conductor on one side, a conductor on the opposite side and a substrate to which at least one of the conductors are attached. Also an antenna is provided, which incorporate the electro-magnetic transmission line system to transmit the radiation energy.

### CROSS-REFERENCE TO RELATED APPLICATIONS

This application claims priority from U.S. Provisional Application No. 62/523,498, filed Jun. 22, 2017 and U.S. Provisional Application No. 62/431,393, filed on Dec. 7, 2016, the disclosures of which are incorporated herein by reference in their entireties.

### BACKGROUND

### 1. Field

This disclosure relates generally to the field of antennas. More particularly, the disclosure relates to transmission mechanism for conducting electromagnetic energy, particularly suitable for antennas.

### 2. Related Art

Common methods of conducting electromagnetic energy between locations are to use a circuit board with microstrip printed technology or using a metallic wave-guide. The advantage of a circuit board over a waveguide is that it can be produced in higher volumes and is flat. The disadvantage is the loss which is proportional to the distance the high frequency electronic signal travels. The advantage of a metallic wave-guide is that it operates with lower losses, but the disadvantage is that it is neither as thin as a circuit board nor as cost effective.

Some circuit board substrates are designed to have low propagation losses. The typical low loss substrate is a mixture of Teflon and glass. However, these Circuit Boards are more expensive because of the process of pressing the Teflon and glass flat, which requires tremendous pressure.

One problem with many low loss materials like Polytetrafluoroethylene, (commonly called Teflon®), is that the thermal expansion and contraction rates for these materials is very different than that for the conductive metals, which they would otherwise be bonded to. For example, if a copper line is formed on Teflon, the Teflon will expand with temperature at a different rate than the copper, and therefore de-laminate the copper. The current art for dealing with this expansion problem is to load the Teflon material with glass to reduce its coefficient of thermal expansion, along with substantial other processes.

Another problem with many low loss materials like Teflon is that they have low surface energy, making it difficult to bond to a conductive circuit. In many instances, glues, or other adhesives are used and these materials have negative RF propagation factors.

Accordingly, a need exists in the art for improved transmission vehicles for electromagnetic energy, which can be used, e.g., in antennas used for wireless communication.

### SUMMARY OF THE INVENTION

The following summary of the disclosure is included in order to provide a basic understanding of some aspects and features of the invention. This summary is not an extensive overview of the invention and as such it is not intended to particularly identify key or critical elements of the invention or to delineate the scope of the invention. Its sole purpose is to present some concepts of the invention in a simplified form as a prelude to the more detailed description that is presented below.

Disclosed embodiments enable a flat and low loss material with the benefits of a circuit board at a much lower cost. In disclosed examples the embodiments are applied to an antenna, but it could be applied to other devices which require high frequency electronic transmission, such as microwaves, radars, LIDAR, etc.

In the disclosed embodiments no glass loading of the substrate material is necessary. The dielectric material, e.g., Teflon®, is free to thermally change size in the x, y and z dimension without any delamination possibility. This is because the copper is not bonded to the dielectric material, but merely maintained in proximate contact, allowing the dielectric material to slide under the copper without affecting the electron flow between the copper and the ground plane.

In some embodiments a film substrate is chemically or mechanically bonded to the conducting circuitry on one side and pressure is applied to the film substrate with a force vector in the direction of the dielectric plate to maintain the dielectric plate and the conductor circuitry attached to the substrate in proximate contact with each other.

In some embodiments the conducting material is chemically or mechanically bonded to one side of the substrate and pressure is applied to the conducting material with a force vector in the direction of the low dielectric material to maintain the low dielectric material and the conductor attached to the substrate in close proximity with each other.

In some embodiments a conducting circuitry is mechanically held between two insulating substrates.

In disclosed embodiments the force vector may be maintained using, e.g., dielectric bolts or dielectric pins.

According to further embodiments, a high performance electro-magnetic transmission system is provided which includes a low dielectric material and two substrate materials in proximate contact with the low dielectric material where at least one of the substrate materials is without a chemical or mechanical bond to the low dielectric material and is mechanically or electrically attached to a conductor material located electrically opposite the low dielectric material.

According to disclosed aspects, a method of fabricating a high performance electro-magnetic transmission line system is provided, comprising: obtaining a substrate; positioning a first conductive circuitry onto a first surface of the substrate; obtaining an insulating plate; positioning a second conductive circuitry onto a first surface of the insulating plate; and, attaching the substrate to the insulating plate. The method may further comprise applying pressure to maintain at least one of the first and second conductive circuitry in proximate contact with the insulating plate. The method may further comprise inserting dielectric pins through the insulating plate.

### BRIEF DESCRIPTION OF THE DRAWINGS

Other aspects and features of the invention would be apparent from the detailed description, which is made with reference to the following drawings. It should be appreciated that the detailed description and the drawings provides various non-limiting examples of various embodiments of the invention, which is defined by the appended claims.

The accompanying drawings, which are incorporated in and constitute a part of this specification, exemplify the embodiments of the present invention and, together with the description, serve to explain and illustrate principles of the invention. The drawings are intended to illustrate major features of the exemplary embodiments in a diagrammatic manner. The drawings are not intended to depict every feature of actual embodiments nor relative dimensions of the depicted elements, and are not drawn to scale.

FIG. 1 is a cross-section of an embodiment of the transmission apparatus.

FIG. 2 illustrates another embodiment of the transmission apparatus.

FIG. 3 illustrates yet another embodiment of the transmission apparatus.

FIG. 4 illustrates another embodiment wherein both the circuitry and the ground are provided on a substrate.

FIG. 5 illustrates an embodiment wherein two dielectric plates are used.

FIG. 6 illustrates another embodiment wherein two dielectric plates are used, while FIG. 6A illustrates a variation wherein the dielectric plate is eliminated.

FIG. 7 illustrates an embodiment having multi-layer conductive circuit and having a radiating patch to form an antenna.

FIGS. 8A-8C illustrate an example of an antenna incorporating conductive lines according to any of the embodiments described herein.

### DETAILED DESCRIPTION

Embodiments of the inventive electrical transmission mechanism will now be described with reference to the drawings. Different embodiments or their combinations may be used for different applications or to achieve different benefits. Depending on the outcome sought to be achieved, different features disclosed herein may be utilized partially or to their fullest, alone or in combination with other features, balancing advantages with requirements and constraints. Therefore, certain benefits will be highlighted with reference to different embodiments, but are not limited to the disclosed embodiments. That is, the features disclosed herein are not limited to the embodiment within which they are described, but may be “mixed and matched” with other features and incorporated in other embodiments.

Disclosed embodiments utilize multiple layers of insulating and conductive materials, which are made to be contiguous with each other, therefore creating a low loss high frequency transmission medium. The layers in one example include: a thin film carrier material (e.g., polyimide), a copper circuit, a dielectric plate of low loss material, e.g., Teflon, and a plate of conductive material to act as a ground plane.

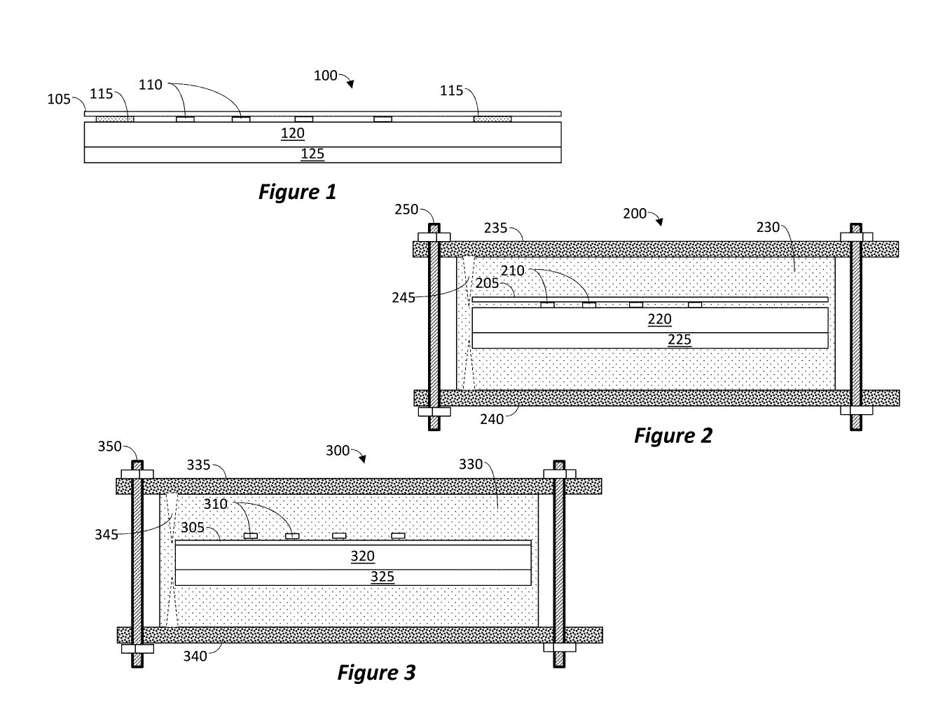

FIG. 1 illustrates a cross-section of one embodiment utilizing the multiple layers approach. The transmission apparatus 100 of this embodiment comprises a carrier 105 made of thin film, such as e.g., polyimide, thus sometimes referred to herein as film substrate. The conductive circuit 110 is formed on the carrier 105 by, e.g., depositing, plating, or adhering a conductive circuit 110. The conductive circuit 110 may be made of, e.g., copper, which is formed using the appropriate circuit diagram. The carrier 105 is attached to a dielectric plate 120, which may be, e.g., PTFE (Polytetrafluoroethylene or Teflon®), PET (Polyethylene terephthalate), Rogers® (FR-4 printed circuit board substrate), or other low loss material. The carrier is attached to a dielectric plate 120 such that the conductive circuit 110 is sandwiched in between the carrier 105 and the dielectric plate 120. Optionally, adhesive 115 is provided between the carrier 105 and the dielectric plate 120. A conductive coating 125 is provided at the bottom of the dielectric plate 120 and serves as a common ground for the signal transmitted in the conductive circuit 110.

FIG. 2 illustrates another embodiment, which utilizes a compression method to keep the conductive circuit 210 and conductive ground 225 in proximate contact with the dielectric plate 220. Specifically, as in FIG. 1, in the embodiment of FIG. 2 a conductive circuit 210 is formed, e.g., deposited, plated, or adhered on the thin-film carrier 205. This thin-film carrier 205 is placed on top of the dielectric plate 220, with the conductive circuit 210 in between thin-film carrier 205 and the dielectric plate 220. Also, a conductive coating 225 is provided at the bottom of the dielectric plate 220 and serves as a common ground for the signal transmitted in the conductive circuit 210. This complete assembly is placed inside compressive insulator 230. The compressive insulator is compressed by bolts 250 operating on top retainer plate 235 and bottom retaining plate 240. For example, either or both of the top and bottom retaining plates may be part of a housing in which the transmission arrangement is installed.

In the example of FIG. 2, the top retainer plate 235 is held at a specific distance from the bottom retaining plate 240 by the use of bolts and nuts arrangement 250. This limits the combined forces applied to the compressive insulator 230, and thus limit the pressure applied to the complete assembly of the transmission apparatus. The pressure is designed to press the carrier 205 against the conductive circuit 110, holding it tight to the dielectric plate 220. Similarly, the conductive coating 225 is pressed against the dielectric plate 225 by the bottom retaining plate 240. The amount of pressure can be designed so as to enable slippage between the dielectric plate 220 and the conductive circuit 210 during thermal expansion.

In some embodiments, the internal assembly of the thin-film carrier 205, conductive circuit 210, dielectric plate 220 and common ground 225 can be aligned and held in lateral alignment. In the example of FIG. 2 the compressive material 230 is the used to maintain lateral alignment. Alternatively, or additionally, lateral alignment means 245, such as, e.g., pins, welding, gluing, etc., can be used to maintain lateral registration, while allowing the variation of expansion of the materials. In one specific embodiment the lateral alignment means 245 are pins made of dielectric material, such as Teflon.

While the pins are showed only in one location, such pins could also be combined with the bolts of 250 and placed through the materials of 225, 220 and 210 in such a way to not interfere with the RF properties of the conductive circuit 210 and ground plane 225. In such an embodiment the pins could be made of a similar or matching low dielectric material such as that found in 220 so that the pins may be located near the circuits of 210 without negatively effecting the RF properties of the circuits.

Thus, as can be understood, according to one aspect, an electro-magnetic transmission line system is provided, comprising: a film substrate; a conductive circuit positioned on one surface of the film substrate; a dielectric plate having a first surface contacting the film substrate; and a conductive ground attached to or in proximate contact to a second surface of the dielectric plate. The conductive circuit may be sandwiched between the film substrate and the dielectric plate, and can be attached to the film substrate and not attached to the dielectric plate. A top retaining member may be positioned over the film substrate and a bottom retaining member may be positioned over the conductive ground, and a pressure applicator may apply compressive force to the top retaining member and the bottom retaining member. A plurality of aligners may be configured to maintain lateral alignment between the film substrate and the dielectric plate. The dielectric plate may be made of: Polytetrafluoroethylene, Polyethylene terephthalate, glass fiber impregnated Polypropylene, or other Polypropylene material.

It should be noted that in the embodiments of FIGS. 1 and 2, the method of forming or bonding the conductive circuit 210 to the carrier 205 does not impact the electrical signal transmission flowing between the conductive circuit and the common ground 225. The transmission is governed by the thickness of the dielectric plate 220 and its dielectric constant. Thus, a wide variety of bonding adhesives or forming methods can be used with less concern over imparting transmission loss.

In yet another example, illustrated in FIG. 3, the carrier substrate 305 abuts to the dielectric plate 320, such that the carrier substrate 305 can easily slip with respect to the dielectric plate 320. As can be seen, the elements of the embodiment of FIG. 3 are the same as that of FIG. 2, except that the carrier substrate 305 is flipped, so that the conductive circuit 310 is away from the dielectric plate 320. This version can work with minimal loss imparted by forming the carrier substrate 305 thin enough or by properly choosing material having the proper dielectric constant. In this case, the effective dielectric constant is the combination of the dielectric constant of the dielectric plate 320 and the dielectric constant of the carrier 305. However, by making the carrier very thin, its contribution to the effective dielectric constant may become negligible.

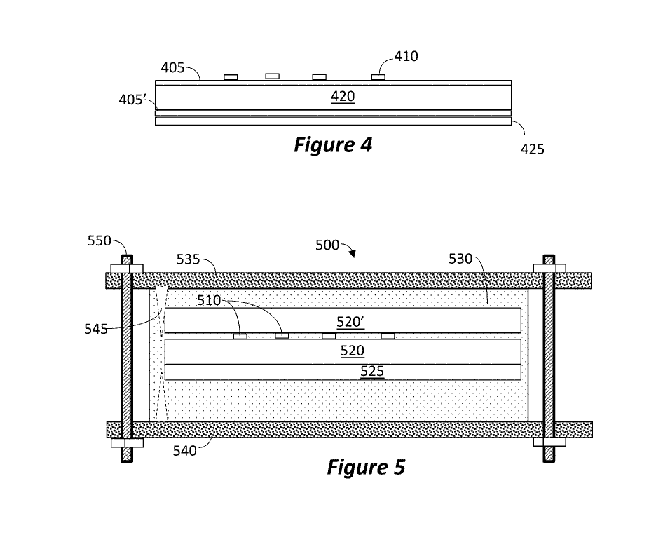

FIG. 4 illustrates another embodiment wherein both the circuitry and the ground are provided on a film substrate. Specifically, as before, the conductive circuitry 410 is formed on a film substrate 405, such as polyimide. However, in this embodiment the common ground 425 is also formed on a film substrate 405′, which may also be polyimide. The two substrates, 405 and 405′ are then brought to contact the dielectric plate 420. In this manner, none of the conductive lines 410 or 425 contact the dielectric plate. The film substrates can be attached to or held against the dielectric plate 420 by any suitable means.

The general method of fabricating any of the disclosed embodiments includes forming the conductive circuitry over one surface of a carrier substrate, which is made of an insulative film. The fabrication of the conductive circuitry may be done by, e.g., sputtering deposition, electro or electroless plating, adhering copper lines onto the substrate, etc. Similarly, a conductive common ground is fabricated on one surface of the dielectric plate. The fabrication of the common ground may be done by, e.g., sputtering deposition, electro or electroless plating, adhering copper film onto the dielectric plate, etc. The thickness and material of the dielectric plate is selected according to the frequency and bandwidth of the transmission signal. The film substrate is then placed in contact with the bare surface of the dielectric plate, i.e., the surface opposite the common ground. In one example, e.g., FIGS. 1 and 2, the film substrate is placed such that the conductive circuitry is sandwiched between the film substrate and the dielectric plate. Alternatively, e.g., FIGS. 3 and 4, the film substrate is placed such that its bare surface, opposite the surface with the conductive circuitry, contacts the bare surface of the dielectric plate. Regardless of the orientation, the film substrate may be adhered to the dielectric plate, or can be made to hold in place using other mechanical means, such as compressive pressure. The compressive pressure may be applied through a compressive member, which may be compressed using bolts and nuts.

On the other hand, FIG. 5 illustrates an example wherein no carrier substrate is used. Rather, a conductive circuit 510 is formed out of conductive material and is placed between two dielectric plates 520 and 520′. The conductive circuit 510 need not be adhered to either of the dielectric plates 520 or 520′, rather it is held in place by the pressure acting on the two dielectric plates 520 and 520′. Dielectric aligning pins 545 can be used to maintain the conductive circuit 510 at a desired location within the transmission structure.

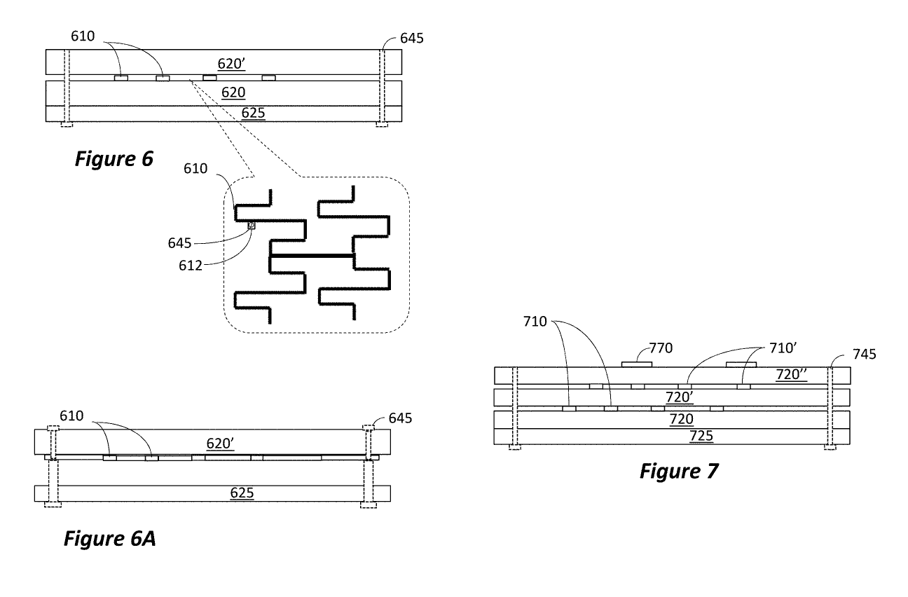

FIG. 6 illustrates another embodiment wherein no carrier substrate is utilized. Rather, as with the embodiment of FIG. 5, the conductive circuit 610 is formed of a conductive material, and has a desired circuitry shape, as exemplified in the top view shown in the callout of FIG. 6. The conductive circuit 610 is placed between two dielectric plates 620 and 620′. A ground plate 625 is placed below dielectric plate 620, to be at a pre-designed separation distance from the conductive circuit 610. The entire assembly is held together by pins 645. In this embodiment, which may be also utilized in any of the other embodiments described herein, pins 645 are made of dielectric material, such as Teflon. Once the pins 645 are inserted into the assembly, a hot iron is used to fuse them into place, thus holding the entire assembly together.

While for clarity the pins are shown at the edges of the image, the pins could also be placed internal to the picture in the quantity necessary to ensure proper alignment in the x, y and z directions.

As also shown in the callout of FIG. 6, another option is to have alignment structures 612 in the conductive circuit 610. When placing the conductive circuit in between the dielectric plates 620 and 620′ the alignment structures 612 are aligned with holes provided in the dielectric plates 620 and 620′. Then the dielectric pins are inserted in the holes, thus maintaining the alignment of the conductive circuit 610. The hot iron is then used to fuse the ends of the dielectric pins and holes the entire assembly together.

As shown in FIG. 6, it is possible to include alignment structures 612 in the conductive circuit. In such a case, it is possible to completely eliminate the dielectric plate 620 between the conductive circuit and the ground plane, thus having just air, which provides the least losses in transmission. Such an arrangement in illustrated in FIG. 6A. In order to maintain the separation distance between the conductive circuit 610 and ground plate 625 at a desired length, in this embodiment the dielectric pins 645 are made of two different diameters along its length: a wide diameter to a length of the desired separation, and a narrower width at the remaining of the length. The interior diameter of the alignment elements 612 is made such that it fits over the small diameter of the dielectric pin 645, but too small to pass the larger diameter of the pin 645. Thus, the conductive circuit is held at a distance determined by the length of the large diameter part of the dielectric pin 645.

Thus, according to the embodiment illustrated in FIG. 6A, a low losses transmission circuitry is provided, comprising: a conductive ground plane; a conductive circuitry plate; a plurality of dielectric pins inserted though the conductive ground plane and the conductive circuitry plate; wherein the dielectric pins comprise means to maintain the conductive circuitry plate at a designated separation distance from the conductive ground plane. The means to maintain the separation distance may comprise the pins having multiple diameters along the length of the pins.

FIG. 7 illustrates an embodiment wherein a multi-layer conductive circuit 710 and 710′ is implemented in an antenna structure. Of course, while only two layers of conductive circuit are shown in FIG. 7, any number of conductive circuit layers can be implemented. The structure of the embodiment of FIG. 7 includes, starting from the bottom: a common ground plane 725, a bottom dielectric plate 720, a first conductive circuit 710, an intermediate dielectric plate 720′ a second conductive circuit 710′, a top dielectric plate 720″, and radiating patches 770. The entire assembly in this example is held in place using the dielectric pins which are fused using hot iron.

Thus, according to the embodiment illustrated in FIG. 7, and antenna incorporating a low losses transmission circuitry is provided, comprising: an insulative spacer plate; a radiating patch positioned on the insulative spacer plate; a dielectric plate; a conductive circuit positioned over one surface of the dielectric plate and in slidable relationship thereto; and a conductive ground positioned on a second surface of the dielectric plate, opposite the conductive circuit.

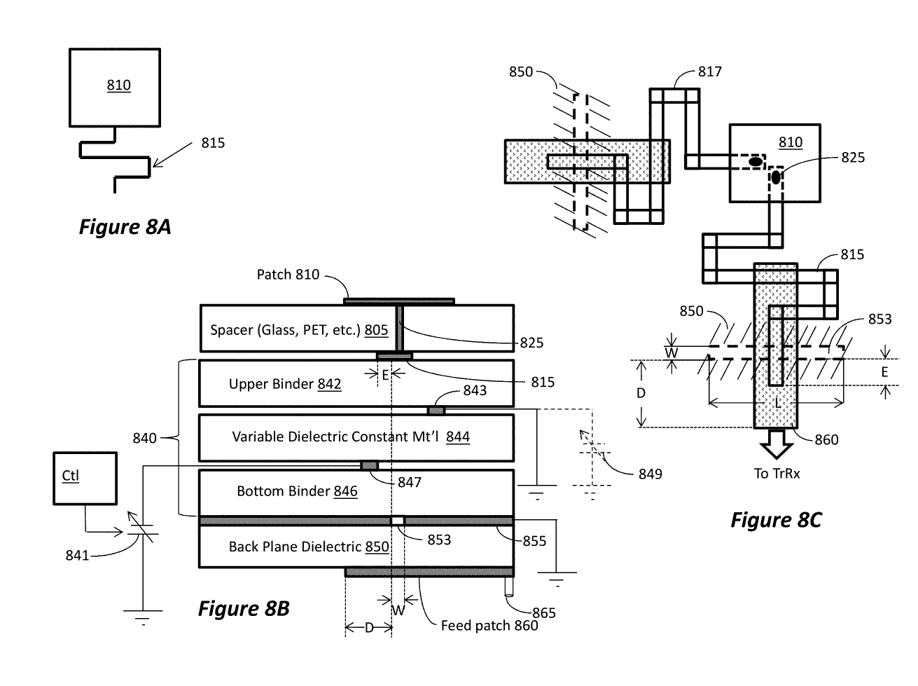

An example of an antenna that can utilize the feeding structure disclosed herein can be better understood from the following description of FIGS. 8A and 8B, with further reference to FIG. 8C. FIG. 8A illustrates a top view of a single radiating element 810, while FIG. 8B illustrates a cross section of relevant sections of the antenna at the location of the radiating element 810 of FIG. 8A. FIG. 8C provides a top “transparent” view that is applicable to the embodiment of FIGS. 8A and 8B.

A top dielectric spacer 805 is generally in the form of a dielectric (insulating) plate or a dielectric sheet, and may be made of, e.g., glass, PET, etc. The radiating patch 810 is formed over the spacer by, e.g., adhering a conductive film, sputtering, printing, etc. At each patch location, a via may be formed in the dielectric spacer 805 and is filled with conductive material, e.g., copper, to form contact 825, which connects physically and electrically to radiating patch 810. A delay line 815 is formed on the bottom surface of dielectric spacer 805 (or on top surface of upper binder 842), and is connected physically and electrically to contact 825. That is, there is a continuous DC electrical connection from the delay line 815 to radiating patch 810, through contact 825. As shown in FIG. 8A, the delay line 815 is a meandering conductive line and may take on any shape so as to have sufficient length to generate the desired delay, thereby causing the desired phase shift in the RF signal.

The delay in the delay line 815 is controlled by the variable dielectric constant (VDC) plate 840 having variable dielectric constant material 844. While any manner for constructing the VDC plate 840 may be suitable for use with the embodiments of the antenna, as a shorthand in the specific embodiments the VDC plate 840 is shown consisting of upper binder 842, (e.g., glass PET, etc.) variable dielectric constant material 844 (e.g., twisted nematic liquid crystal layer), and bottom binder 846. In other embodiments one or both of the binder layers 842 and 844 may be omitted. Alternatively, adhesive such as epoxy or glass beads may be used instead of the binder layers 842 and/or 844.

In some embodiments, e.g., when using twisted nematic liquid crystal layer, the VDC plate 840 also includes an alignment layer that may be deposited and/or glued onto the bottom of spacer 805, or be formed on the upper binder 842. The alignment layer may be a thin layer of material, such as polyimide-based PVA, that is being rubbed or cured with UV in order to align the molecules of the LC at the edges of confining substrates.

The effective dielectric constant of VDC plate 840 can be controlled by applying AC or DC potential across the VDC plate 840. For that purpose, electrodes are formed and are connected to controllable voltage potential. There are various arrangements to form the electrodes, and several examples will be shown in the disclosed embodiments. In the arrangement shown in FIG. 8B, two electrodes 843 and 847 and provided—one on the bottom surface of the upper binder 842 and one on the upper surface of the bottom binder 846. As one example, electrode 847 is shown connected to variable voltage potential 841, while electrode 843 is connected to ground. As one alternative, shown in broken line, electrode 843 may also be connected to a variable potential 849. Thus, by changing the output voltage of variable potential 841 and/or variable potential 849, one can change the dielectric constant of the VDC material in the vicinity of the electrodes 843 and 847, and thereby change the RF signal traveling over delay line 815. Changing the output voltage of variable potential 841 and/or variable potential 849 can be done using a controller, Ctl, running software that causes the controller to output the appropriate control signal to set the appropriate output voltage of variable potential 841 and/or variable potential 849. Thus, the antenna's performance and characteristics can be controlled using software—hence software controlled antenna.

At this point it should be clarified that in the subject description the use of the term ground or common ground refers to both the generally acceptable ground potential, i.e., earth potential, and also to a common or reference potential, which may be a set potential or a floating potential. Similarly, while in the drawings the symbol for ground is used, it is used as shorthand to signify either an earth or a common potential, interchangeably. Thus, whenever the term ground is used herein, the term common or reference potential, which may be set or floating potential, is included therein.

As with all RF antennas, reception and transmission are symmetrical, such that a description of one equally applies to the other. In this description it may be easier to explain transmission, but reception would be the same, just in the opposite direction.

In transmission mode the RF signal is applied to the feed patch 860 via connector 865 (e.g., a coaxial cable connector). As shown in FIG. 8B, there is no electrical DC connection between the feed patch 860 and the delay line 815. However, in disclosed embodiments the layers are designed such that an RF short is provided between the feed patch 860 and delay line 815. As illustrated in FIG. 8B, a back plane conductive ground (or common) 855 is positioned between the top surface of back plane insulator (or dielectric) 850 and the bottom surface of bottom binder 846. The back plane conductive ground 855 is generally a layer of conductor covering the entire area of the antenna array. At each RF feed location a window (DC break) 853 is provided in the back plane conductive ground 855. The RF signal travels from the feed patch 860, via the window 853, and is coupled to the delay line 815. The reverse happens during reception. Thus, a DC open and an RF short are formed between delay line 815 and feed patch 860.

In one example the back plane insulator 850 is made of a Rogers® (FR-4 printed circuit board) and the feed patch 860 may be a conductive line formed on the Rogers. Rather than using Rogers, a PTFE (Polytetrafluoroethylene or Teflon®) or other low loss material may be used.

To further understand the RF short (also referred to as virtual choke) design of the disclosed embodiments, reference is made to FIG. 8C. FIG. 8C illustrates an embodiment with two delay lines connected to a single patch 810, such that each delay line may carry a different signal, e.g., at different polarization. The following explanation is made with respect to one of the delay lines, as the other may have similar construction.

In FIG. 8C the radiating patch 810 is electrically DC connected to the delay line 815 by contact 825 (the delay line for the other feed is referenced as 817). So, in this embodiment the RF signal is transmitted from the delay line 815 to the radiating patch 810 directly via the contact 825. However, no DC connection is made between the feed patch 860 and the delay line 815; rather, the RF signal is capacitively coupled between the feed patch 860 and the delay line 815. This is done through an aperture in the ground plane 850. As shown in FIG. 3B, the VDC plate 840 is positioned below the delay line 815, but in FIG. 8C it is not shown, so as to simplify the drawing for better understanding of the RF short feature. The back ground plane 850 is partially represented by the hatch marks, also showing the window (DC break) 853. Thus, in the example of FIG. 8C the RF path is radiating patch 810, to contact 825, to delay line 815, capacitively through window 850 to feed patch 860.

For efficient coupling of the RF signal, the length of the window 853, indicated as “L”, should be set to about half the wavelength of the RF signal traveling in the feed patch 860, i.e., λ/2. The width of the window, indicated as “W”, should be set to about a tenth of the wavelength, i.e., λ/10. Additionally, for efficient coupling of the RF signal, the feed patch 860 extends about a quarter wave, λ/4, beyond the edge of the window 853, as indicated by D. Similarly, the terminus end (the end opposite contact 825) of delay line 815 extends a quarter wave, λ/4, beyond the edge of the window 853, as indicated by E. Note that distance D is shown longer than distance E, since the RF signal traveling in feed patch 860 has a longer wavelength than the signal traveling in delay line 815.

It should be noted that in the disclosure, every reference to wavelength, indicates the wavelength traveling in the related medium, as the wavelength may change as it travels in the various media of the antenna according to its design and the DC or AC potential applied to variable dielectric matter within the antenna.

As explained above, in the example of FIG. 8C the RF signal path between the delay line and the radiating patch is via a resistive, i.e., physical conductive contact. On the other hand, a variation wherein the RF signal path between the delay line and the radiating patch is capacitive, i.e., there's no physical conductive contact between them, can also be implemented.

In the embodiment of FIGS. 8A-8C, any single or combination of the conductive elements, e.g., delay line 815, electrode 843, electrode 847, conductive ground 855 and feed patch 860 may be implemented according to any of the embodiments described herein.

As reflected from the above detailed description, a disclosed aspect involves a high performance electro-magnetic transmission system, comprising: an insulating plate comprising a low dielectric material; a first conductive circuit proximate a first surface of the insulating plate; a second conductive circuit proximate a second surface of the insulating plate; and wherein at least one of the first and second conductive circuits is without a chemical or mechanical bond to the insulating plate and is mechanically pressed against the insulating plate. The system may further comprise a substrate abutting the insulating plate, and wherein at least one of the first and second conductive circuits is mechanically or chemically attached to the substrate. The system may further comprise compressive means configured to exert compressive force between the substrate and the insulating plate. The compressive means may comprise a top retaining member positioned over the substrate and a bottom retaining member positioned over the insulating plate, and a pressure applicator applying compressive force to the top retaining member and the bottom retaining member. The insulating plate may be made of: Polytetrafluoroethylene, Polyethylene terephthalate, glass fiber impregnated Polypropylene, or other Polypropylene material

It should be understood that processes and techniques described herein are not inherently related to any particular apparatus and may be implemented by any suitable combination of components. Further, various types of general purpose devices may be used in accordance with the teachings described herein. The present invention has been described in relation to particular examples, which are intended in all respects to be illustrative rather than restrictive. Those skilled in the art will appreciate that many different combinations will be suitable for practicing the present invention.

Moreover, other implementations of the invention will be apparent to those skilled in the art from consideration of the specification and practice of the invention disclosed herein. Various aspects and/or components of the described embodiments may be used singly or in any combination. It is intended that the specification and examples be considered as exemplary only, with a true scope and spirit of the invention being indicated by the following claims.

1. An electro-magnetic transmission line system, comprising:
a film substrate;
a conductive circuit positioned on one surface of the film substrate;
a dielectric plate having a first surface contacting the film substrate;
a conductive ground in proximate contact to a second surface of the dielectric plate.

2. The system of claim 1, wherein the conductive circuit is sandwiched between the film substrate and the dielectric plate.

3. The system of claim 1, wherein the conducting circuit is attached to the film substrate and is not attached to the dielectric plate.

4. The system of claim 1, further comprising a top retaining member positioned over the film substrate and a bottom retaining member positioned over the conductive ground, and a pressure applicator applying compressive force to the top retaining member and the bottom retaining member.

5. The system of claim 1, wherein a second surface of the dielectric plate, opposite the first surface, abuts the film substrate opposite the one surface having the conductive circuit.

6. The system of claim 1, further comprising aligners configured to maintain lateral alignment between the film substrate and the dielectric plate.

7. The system of claim 6, wherein the aligners comprise dielectric pins.

8. The system of claim 1, wherein the film substrate comprises polyimide.

9. The system of claim 1, wherein the dielectric plate comprises one of: Polytetrafluoroethylene, Polyethylene terephthalate, glass fiber impregnated Polypropylene, or Polypropylene material.

10. A high performance electro-magnetic transmission system comprising an insulating plate comprising a low dielectric material; a first conductive circuit proximate a first surface of the insulating plate; a second conductive circuit proximate a second surface of the insulating plate; and wherein at least one of the first and second conductive circuits is without a chemical or mechanical bond to the insulating plate and is mechanically pressed against the insulating plate.

11. The system of claim 10, further comprising a substrate abutting the insulating plate, and wherein at least one of the first and second conductive circuits is mechanically or chemically attached to the substrate.

12. The system of claim 11, further comprising compressive means configured to exert compressive force between the substrate and the insulating plate.

13. The system of claim 12, wherein the compressive means comprises a top retaining member positioned over the substrate and a bottom retaining member positioned over the insulating plate, and a pressure applicator applying compressive force to the top retaining member and the bottom retaining member.

14. The system of claim 11, wherein the substrate is physically attached to the insulating plate.

15. The system of claim 11, wherein one of the first and second conductive circuits is fixed to the substrate by adhesive.

16. The system of claim 11, wherein one of the first and second conductive circuits is fixed to the substrate by electroless plating.

17. The system of claim 11, wherein the substrate comprises polyimide.

18. The system of claim 10, wherein the insulating plate comprises one of: Polytetrafluoroethylene, Polyethylene terephthalate, or Rogers®.

19. A method of fabricating a high performance electro-magnetic transmission line system, comprising:
obtaining a substrate;
positioning a first conductive circuitry onto a first surface of the substrate;
obtaining an insulating plate;
positioning a second conductive circuitry onto a first surface of the insulating plate; and,
attaching the substrate to the insulating plate.

20. The method of claim 19, wherein attaching the substrate to the insulating plate comprises attaching the substrate to second surface of the insulating plate, opposite the first surface of the insulating plate.

21. The method of claim 19, wherein attaching the substrate to the insulating plate comprises attaching the first surface of the substrate to the second surface of the insulating plate.

22. The method of claim 19, further comprising applying pressure to maintain at least one of the first and second conductive circuitry in proximate contact with the insulating plate.

23. The method of claim 19, further comprising inserting dielectric pins through the insulating plate.
